(19) United States
(12) Patent Application Publication
(10) Pub. No.: US 2008/0172551 A1
(43) Pub. Date: Jul. 17, 2008

(54) OPERATION VERIFICATION METHOD FOR VERIFYING OPERATIONS OF A PROCESSOR

(75) Inventors: Hideo YAMASHITA, Kawasaki (JP); Ryuji Kan, Kawasaki (JP)

Correspondence Address: STAAS & HALSEY LLP, SUITE 700, 1201 NEW YORK AVENUE, N.W., WASHINGTON, DC, 20005, US

(73) Assignee: FUJITSU LIMITED, Kawasaki (JP)

(21) Appl. No.: 12/028,371

(22) Filed: Feb. 8, 2008

Related U.S. Application Data
(63) Continuation of application No. PCT/JP2005/023510, filed on Dec. 21, 2005.

(30) Foreign Application Priority Data
Aug. 8, 2005 (JP) 2005-229067

(51) Int. Cl. G06F 9/30

(52) U.S. Cl. 712/227; 714/735; 712/E09.016

(57) ABSTRACT

To verify an addition-function of a floating-point adder-subtractor in a processor, parameters such as the number of verification patterns of a verification program are set, a floating-point addition instruction to be verified is created, and operands used for this addition are created at random. The floating-point addition instruction thus created is emulated only by a fixed-point instruction and processed only by using the fixed-point execution element, thereby creating an expectation value. The floating-point addition instruction is computed by using the floating-point adder-subtractor to be verified, and the created expectation value is compared with the operation result. If they do not correspond to each other, the set number of operation patterns is checked. If the number has reached a prescribed value, the operation verification is terminated in the normal manner.

### CROSS REFERENCE TO RELATED APPLICATION

This application is a continuation of the PCT application PCT/JP2005/023510 which was filed on Dec. 21, 2005.

### BACKGROUND OF THE INVENTION

1. Field of the Invention

The present invention relates to an operation verification method for verifying the operations of a processor, and particularly to a technique for verifying the operations of a processor by using a program for generating instructions and expectation values.

2. Description of the Related Art

In recent years, the performance level demanded of server computers has increased, and the logic in the processors for realizing the increase in the performance level of the server computers has become complicated. Also, the degrees of integration in the semiconductor devices have increased too. As the logic has become complicated and the degrees of integration in the semiconductor devices have increased, the periods needed for debugging in the design and preproduction phases of the semiconductor devices are increasing. Thus, it is desirable that the debugging efficiency be increased.

Generally, processors are developed by undergoing preliminary design, detailed design, circuit mounting, logical simulation, verification of the actual product, and product shipment.

Accordingly, in the development of processors, verification that is based on a large number of verification data patterns (test patterns) performed for verifying the logic of the processors in the simulation phase will greatly contribute to better logical qualities in the downstream phases (actual product verification and product shipment).

Also, in the actual product verification of processors, not only logical matters but also physical matters have to be verified, and the physical matters vary from one LSI to another. Thus, verification based on a large number of data patterns is desirable.

As an example of a conventional verification of the logic of an execution element for verifying processors, a method of simulation (Patent Document 1) is known in which an instruction table 801, an operand table 802, and an operation result table 803 are set in a storage region 800 in the main storage unit as shown in FIG. 1, an input operand and an expectation value of the result are stored in the operand table 802 and the operation result table 803, the operand that is the same as the operand stored in the operand table 802 is executed on the logical simulation model of the execution element (not shown), and the execution result and the expectation value stored in the operation result table 803 are compared to each other.

Also, in the design phase, a logical simulation model for the processor is created, and an operation verification program is executed on the model in order to verify the operations of the processor. Further, when the operations of a processor in an actual information processing device are verified, the operation verification program is executed on the information processing device in order to verify the operation of the processor.

However, in the above verification program that uses the instructions, operand, and expectation values in the form of a table, the number of data patterns for the verification program that can be executed for the simulation model or on the actual information processing device depends on the size of the tables, i.e., the size of the verification program. Accordingly, to perform verification on the basis of a large number of data patterns requires an immense program size. Also, even when a program having tables of an immense size is prepared, the size of the program is limited by the size of the logical simulation model or by the memory amount in an information processing device on which the logical simulation model is executed. Accordingly, the size of the program has been limited.

### Patent Document 1:

### Japanese Patent Application Publication No. 07-049887

### SUMMARY OF THE INVENTION

It is an object of the present invention to provide an operation verification method for enabling operation verification on the basis of a large number of data patterns when a simulation for the processor development or the operation verification on an actual information processing device is performed.

In order to attain the above object, the present invention is characterized by being a method for verifying a target execution element, creating a verification instruction, creating an expectation value by executing a program by using another execution element, and comparing the expectation value and a result obtained from an actual verification target execution element.

According to the present invention, operation instructions and input operands are created by the program at random, and thereby it is not necessary to hold verification instruction queues, operands, or expectation values in a table format, and also the expectation value is created by an execution element other than the target execution element; accordingly, it is possible to create significant data patterns almost unlimitedly for the verification of the target execution element.

### BRIEF DESCRIPTION OF THE DRAWINGS

FIG. 1 shows a conventional example of operation verification in a processor;

FIG. 2 shows a block diagram showing a configuration of a processor according to an embodiment of the present invention;

FIG. 3 shows an operation verification process flow according to an embodiment of the present invention for verifying an addition function in a floating-point adder-subtractor in the processor shown in FIG. 2;

FIG. 4 shows an operation verification process flow according to an embodiment of the present invention for verifying an operation function of a floating-point execution element in the processor in FIG. 2;

FIG. 5 shows an example of an instruction format used in an embodiment;

FIG. 6A shows an operation verification program for verifying an addition function in the floating-point adder-subtractor in the processor shown in FIG. 2;

FIG. 6B shows an example of an instruction queue created by the operation verification program shown in FIG. 6A;

FIG. 7A shows an operation verification program for verifying an operation function of the floating-point execution element in the processor shown in FIG. 2;

FIG. 7B shows an example of an instruction queue created by the operation verification program shown in FIG. 7A;

FIG. 7C shows an example of an instruction queue created by adding a method of controlling the type of instruction when creating instructions in the operation verification program shown in FIG. 7A;

FIG. 7D shows another example of an instruction queue created by adding a method of controlling the type of instruction when creating instructions in the operation verification program shown in FIG. 7A; and

FIG. 7E shows an example of an instruction queue created by limiting the number of registers used in an instruction in the operation verification program shown in FIG. 7A.

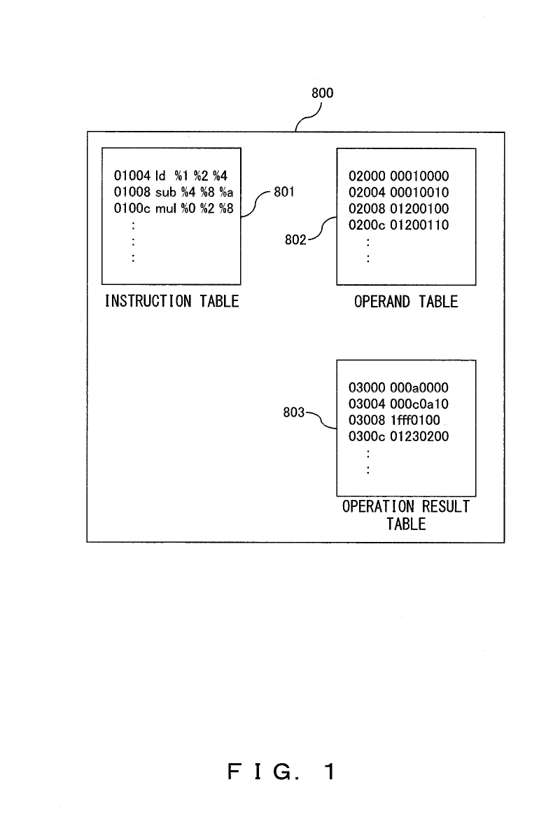

### DESCRIPTION OF THE PREFERRED EMBODIMENTS

Hereinafter, embodiments of the present invention will be explained by referring to the drawings.

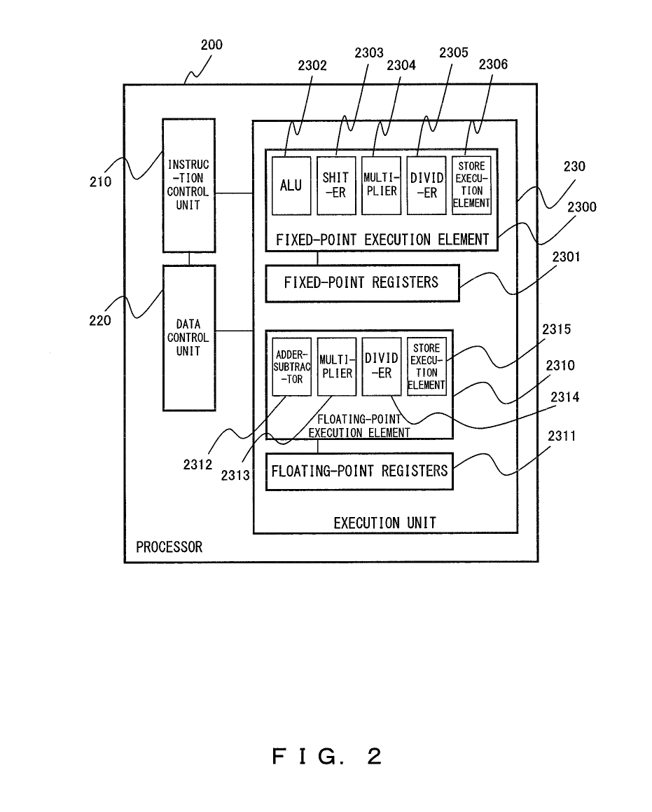

FIG. 2 is a block diagram showing a configuration of a processor according to an embodiment of the present invention. In FIG. 2, a processor 200 that is the target of the operation verification essentially includes an instruction control unit 210, a data control unit 220, and an execution unit 230. The instruction control unit 210 performs the bypass control of an instruction input and the operand caused by the interference of the register. The data control unit 220 sends to the execution unit 230 the data presented by the instruction control unit 210. The execution unit 230 performs execution on the data specified by the instruction control unit 210. The execution unit 230 includes thirty-two fixed-point registers 2301 each consisting of eight bytes, thirty-two floating-point registers 2311 each consisting of eight bytes, an ALU 2302, a shifter 2303, a multiplier 2304, a divider 2305, and a store execution element 2306, which together constitute a fixed-point execution element 2300. Further, the execution element 230 includes an adder-subtractor 2312, a multiplier 2313, a divider 2314, and a store execution element 2315, which together constitute a floating-point execution element 2310.

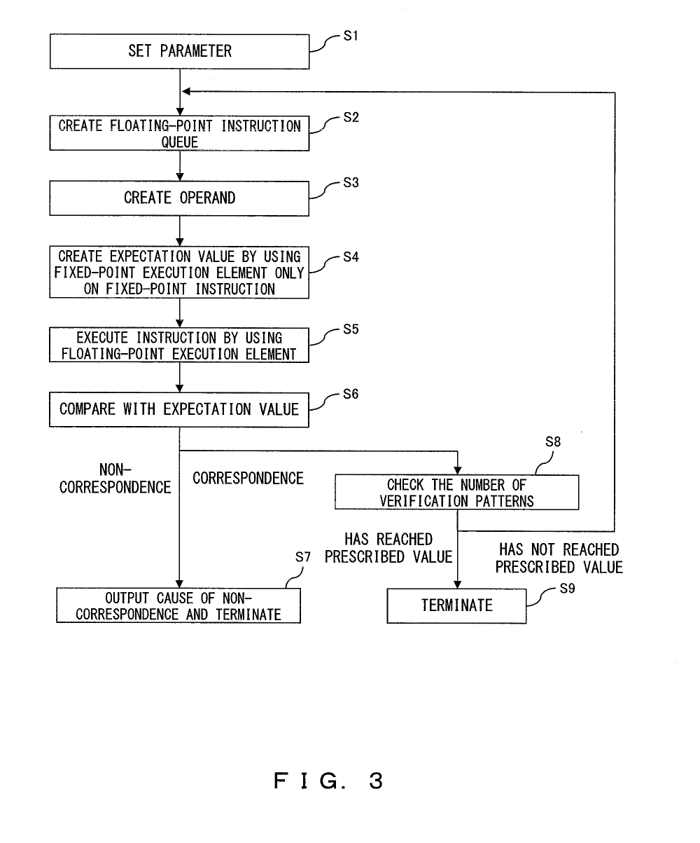

FIG. 3 shows an operation verification process flow according to an embodiment of the present invention for verifying the addition function in the floating-point adder-subtractor in the processor shown in FIG. 2. In step S1 (in FIG. 3 and throughout, “S” denotes “step”), parameters such as the number of verification patterns of the verification program are set. In step S2, the floating-point addition instruction is created as the verification target. In step S3, the operands used for this floating-point addition instruction are created at random. In step S4, the created floating-point addition instruction is emulated only by the fixed-point instruction, and thus the execution process is performed by using only the fixed-point execution element 2300 in the processor, and the expectation value is created. In step S5, the floating-point addition instruction created in step S2 is computed by using the adder-subtractor 2312 that is the verification target. In step S6, the expectation value created by using only the fixed-point execution element 2300 in step S4 is compared with the result of the process in step S5, and when they correspond to each other, the process proceeds to step S8, and when they don't, the process proceeds to step S7. In step S8, the number of verification patterns set in step S1 is checked, and when the number of the verification patterns has not reached the prescribed value, the process returns to step S1, and when the number of the verification patterns has reached the prescribed value, the process proceeds to step S9, and the operation verification is terminated in the normal manner. In step S7, the cause of the non-correspondence is analyzed and is output; thereafter, the operation verification is terminated. In the above method, the operands are created at random as the operation target of the floating-point addition instruction (step S3); accordingly, it is possible to use the immense number of combinations of the operands. Also, the expectation values for the operands are not calculated (step S4) by the fixed-point execution element 2300 that is not the verification target, and accordingly when the adder-subtractor 2312 has a physical or logical problem that causes failure in the execution, the failure in the adder-subtractor 2312 can be detected.

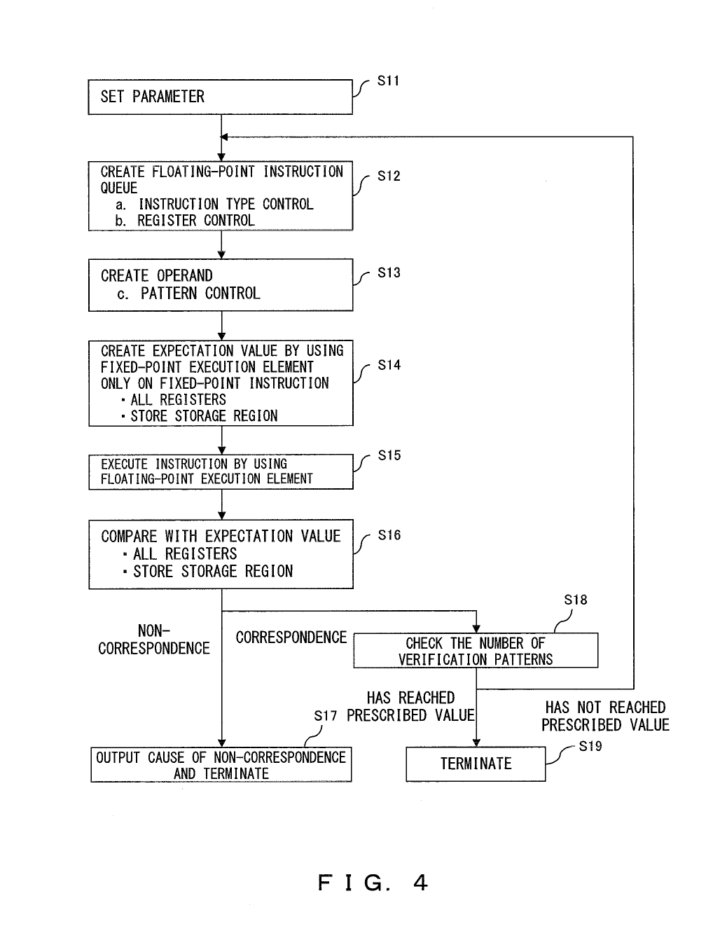

FIG. 4 shows an operation verification process flow according to an embodiment of the present invention for verifying the operation function of the floating-point execution element in the processor in FIG. 2. In step S11, parameters such as the number of verification patterns for the verification program are set. In step S12, a plurality of floating-point instructions are created at random as the verification targets. In step S13, the operand of the floating-point instruction to be verified is created at random. In step S14, the execution of the created floating-point execution instruction is started by using only the fixed-point execution element 2300 in the processor, and the expectation value is created. In the above process, all of the registers and the storage regions stored by the store instruction become the expectation values. Next, in step S15, the execution of the floating-point execution instruction created in step S12 is actually performed. In step S16, the expectation value created in step S14 by using the fixed-point execution element 2300 and the process result of step S15 are compared to each other. When they correspond to each other, the process proceeds to step S18, and when they do not correspond to each other, the process proceeds to step S17. In step S18, the number of verification patterns set in step S11 is checked, and when the number of verification patterns has not reached the prescribed value, the process returns to step S11, while when the number of verification patterns has reached the prescribed value, the process proceeds to step S19 and the operation verification is terminated in the normal manner. In step S17, the cause of the non-correspondence is analyzed and is output, and thereafter the operation verification is terminated.

In the above method, it is possible to continuously operate a plurality of floating-point instructions; accordingly, the verification of instruction control by the interference of the operation data and the data control logic can be performed, and the instruction patterns and the operand data can be created at random, and thereby an immense number of combinations can be verified.

Additionally, by controlling (c. pattern control) the data pattern when creating the operands in step S13 shown in FIG. 4, the operation function that relates to the operands dedicated to the data pattern that is desired to be verified (such as the signs of the operands and the magnitude relationship) can be verified.

Further, by controlling (a. instruction type control) the data pattern when creating the operands in step S12 shown in FIG. 4, instructions having different process timings are combined or the same instructions are made to be sequentially ordered, and thereby it is possible to limit the target execution elements to be verified, and further to verify the instruction input function in the instruction control unit 210.

Still further, by controlling (b. register control) the register used in the instruction created in step S12 shown in FIG. 4, it is possible to control the interference of the operands by the previous and following instructions. Thereby, the instruction input function and the bypass function in the instruction control unit 210 can be verified in addition to the execution unit 230.

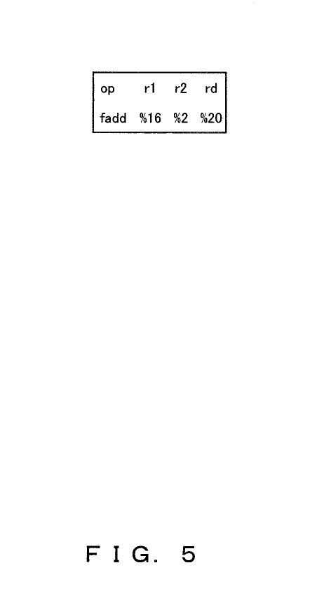

FIG. 5 shows an example of the instruction format used in the present embodiment. In FIG. 5, the symbol “op” denotes an instruction operation code, the symbols “r1” and “r2” denote input register numbers, and the symbol “rd” denotes a result register number. FIG. 5 shows the configuration in which the fadd (floating-point addition) operation is performed on the data on the floating-point registers #16 and #2, and the operation result is set in register #20.

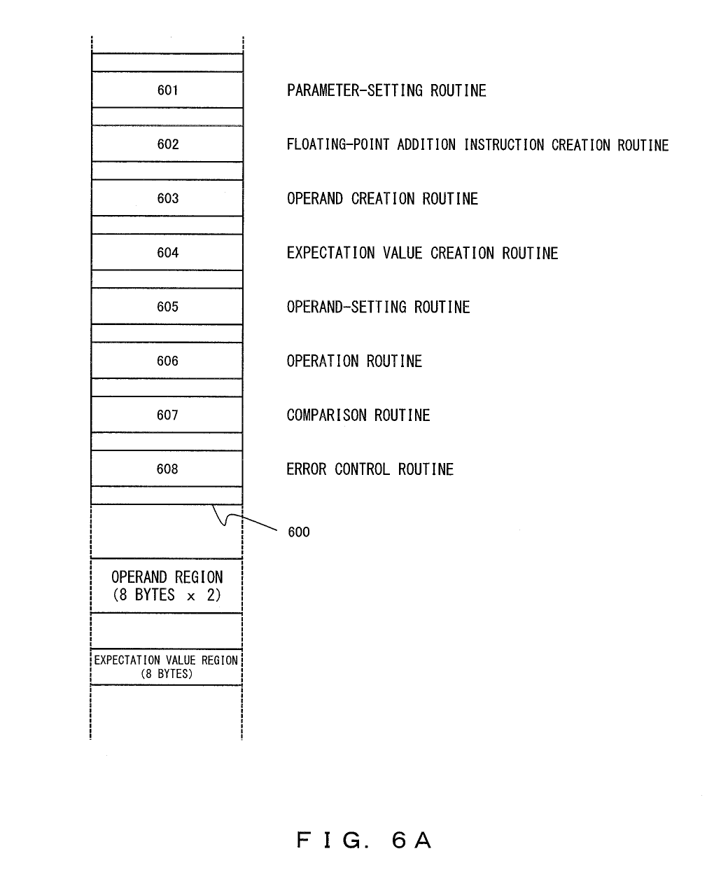

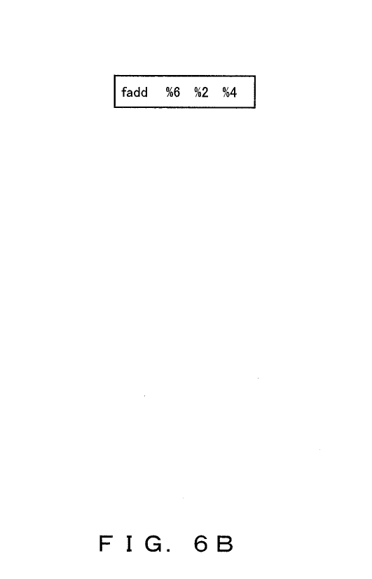

FIG. 6A shows an operation verification program for verifying the addition function in the floating-point adder-subtractor in the processor shown in FIG. 2. In FIG. 6, an operation verification program 600 includes a parameter-setting routine 601, a floating-point addition instruction creation routine 602, an operand creation routine 603, an expectation value creation routine 604 for obtaining an expectation value by simulating, using the fixed-point operation, the floating-point addition instruction created in the floating-point addition instruction creation routine 602, an operand-setting routine 605 for setting operand data in registers, an operation routine 606 for computing, by using the verification target floating-point adder-subtractor, the floating-point addition instruction created in the floating-point addition instruction creation routine 602, a comparison routine 607 for comparing the expectation value obtained by the expectation value creation routine 604 and the value computed by the operation routine 606, and an error control routine 608.

The flow for verifying the floating-point adder-subtractor circuit of the simulation model by using the operation verification program shown in FIG. 6A will be explained.

The floating-point addition of the simulation model is for outputting a result of eight bytes by adding two operands of eight bytes that are set on the specified register. First, the program 600 is loaded into a memory unit of a simulation model. When the program 600 is executed on the verification target model, the number of verification instructions and the number of verification patterns that were given when the program was executed in the parameter setting routine 601 is set. In the present embodiment, “1” is used as the number of verification instructions and “5” is used as the number of verification patterns, as examples. Next, in the floating-point addition instruction creation routine 602, the floating-point addition (fadd) instruction as shown in FIG. 6B is created for one instruction that was set as a parameter in the parameter-setting routine 601. Next, in the operand creation routine 603, the operands that are to be used in this fadd instruction are created at random, and the created operands are set on the operand region on a memory unit. In the expectation value creation routine 604, the fadd instruction is simulated for the operand of the fadd instruction created in the operand creation routine 603 by using the fixed-point execution element, and the execution result is set on an expectation value region on a memory unit.

Next, in the operand-setting routine 605, the operand data stored on the memory unit in the operand creation routine 603 is set in the operand register of the fadd instruction created in the floating-point addition instruction creation routine 602. In the operation routine 606, the fadd instruction created in the floating-point addition instruction creation routine 602 is processed in the verification target floating-point adder-subtractor. In the comparison routine 607, the expectation value on the memory unit and the operation value obtained in the operation routine 606 are compared to each other. When they correspond to each other, it is recognized that the floating-point adder-subtractor is normally operated for this operand in the error control routine 608, the process returns to the floating-point addition instruction creation routine 602, and the verification on a new operand is performed. This returning is repeated until the number of returning times is performed reaches the number of verification patterns set as the parameter in the parameter-setting routine 601, i.e., “5”, and thereafter, the operation verification program is terminated in the normal manner. When they do not correspond to each other, the erroneous termination is reported and the expectation value and the execution value are reported as additional information in the error control routine 608. In the present embodiment, “5” is used as the number of patterns as an example; however, it is possible to verify the floating-point adder-subtractor for a large amount of data without having a table of operands or expectation values by setting the larger number as the number of patterns.

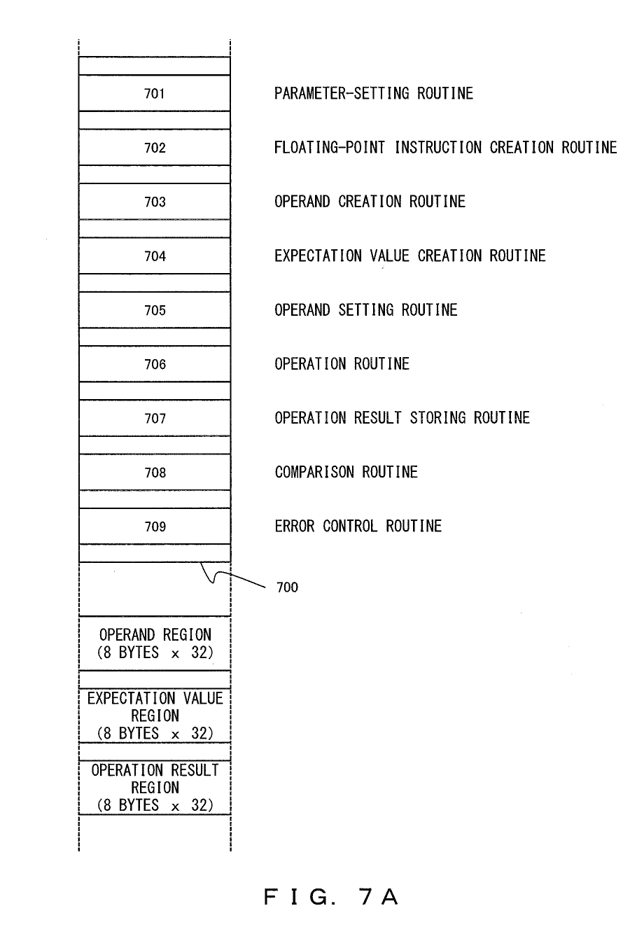

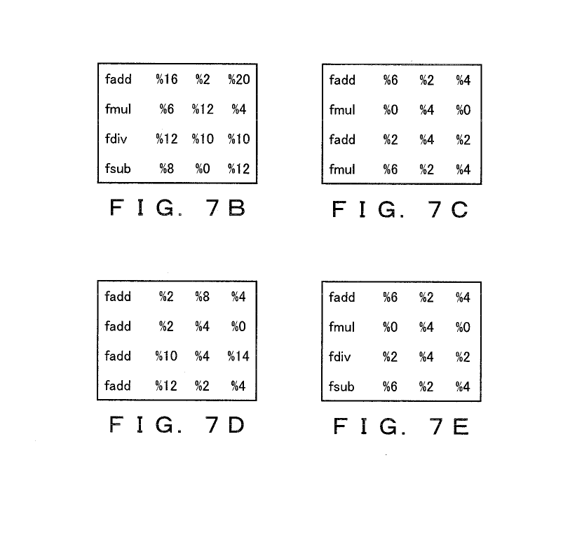

FIG. 7A shows an operation verification program for verifying an operation function of the floating-point execution element in the processor shown in FIG. 2. In FIG. 7A, an operation verification program 700 includes a parameter-setting routine 701; a floating-point instruction creation routine 702; an operand creation routine 703; an expectation value creation routine 704 for obtaining an expectation value by simulating, using the fixed-point execution element, the floating-point instruction created in the floating-point instruction creation routine 702; an operand setting routine 705 for setting operand data in registers; an operation routine 706 for computing, by using the verification target floating-point execution element, the floating-point instruction created in the floating-point instruction creation routine 702; an operation result storing routine 707 for storing, in an operation result region in a memory unit, the register after the execution of the instruction; a comparison routine 708 for comparing the expectation value region obtained by the expectation value creation routine 704 and the operation result region after the operation is stored in the operation result storing routine 707; and an error control routine 709.

A flow for verifying the floating-point execution element by using the operation verification program 700 will be explained below. First, the program 700 is loaded into a memory unit of the simulation model. When the program 700 is executed on the verification target model, the number of instruction patterns and the number of verification patterns given when the verification program was executed in the parameter setting routine 701 is set. In the present embodiment, “4” is used as the number of verification instructions and “5” is used as the number of verification patterns, as examples. Next, four types of instructions set in the parameter routine 701 are created at random in the floating-point instruction creation routine 702. It is assumed that the floating-point addition (fadd) instructions, the floating-point multiplication (fmul) instructions, the floating-point division (fdiv) instructions, and the floating-point subtraction (fsub) instructions are created as shown in FIG. 7B. Further, in the operand creation routine 703, the random operand data is set on the operand region on the memory unit for all of the thirty-two registers. Also, in the expectation value creation routine 704, the values of all the registers before the operation are set in the expectation value region, and the operation results are obtained by simulating all the instructions of fadd, fmul, fdiv, and fsub created in the floating-point instruction creation routine 702 by using the fixed-point execution element, and the results are respectively set in the expectation value regions corresponding to the registers storing the instruction results. Thereby, the values of all the floating-point registers after the execution of the four types of instructions, floating-point addition (fadd), floating-point multiplication (fmul), floating-point division (fdiv), and floating-point subtraction (fsub), are set on the expectation value regions on a memory unit.

Next, the operand to be used in the instruction created in the floating-point instruction creation routine 702 is set in the operand setting routine 705. In the operation routine 706, the fadd instructions, fmul instructions, fdiv instructions, and fsub instructions that were created in the floating-point instruction creation routine 702 are sequentially computed in the verification target floating-point execution element. In the operation result storing routine 707, the values of all the registers after the execution of the instruction are stored in the operation result region on a memory unit. In the comparison routine 708, the expectation region on the memory unit and the operation result region are compared to each other. When they correspond to each other, it is recognized that the floating-point execution element is normally operated for these four instructions or for the operand in the error control routine 709, the process returns to the floating-point instruction creation routine 702, and four floating-point instructions are further created; thereafter, the verification for the new operand is performed. This returning is repeated until the number of returning times is preformed reaches the number of verification patterns set as the parameter in the parameter-setting routine 701, i.e., “5”, and thereafter, the operation verification program is terminated in the normal manner. When the compared values do not correspond to each other, the erroneous termination is reported and the expectation value and the execution value are reported as additional information in the error control routine 709. In the present embodiment, the example of using “4” as the number of instructions and “5” as the number of patterns is used; however, it is possible to verify the floating-point execution element for a larger amount of data for various combinations of instructions without having a table of operands or expectation values.

Next, an example of an operation verification program for verifying the operation function of the floating-point execution element in the processor shown in FIG. 2 will be explained. This program is fundamentally the same as the operation verification program 700. However, the object of this program is to give a setting pattern for operands based on a particular condition in order to verify the operation of a particular circuit that constitutes the floating-point execution element in addition to the verification of the number of instructions and the number of verification patterns in the parameter-setting routine 701. In the present embodiment, an example is used in which a setting operation is performed such that the highest-order bit of the operand is always “0”. In accordance with this setting operation, in the operand creation routine 703, control is performed for creating an operand whose highest-order bit is always “0” by performing the AND operation between a random 8-byte operand and data consisting of “7fffffffffffffff”. The routine 704 and the subsequent routines are the same as those in the operation verification program 700. Thereby, the execution element can be verified while being dedicated to the operand whose highest-order bit is “0” by controlling the operand in the routine 703.

In addition, an example of performing a setting operation such that the highest-order bit of the operand is always “1” will be explained. In accordance with this setting operation, control is performed for creating an operand whose highest-order bit is always “1” by performing the OR operation on a random 8-byte operand and data consisting of “8000000000000000” in the operand creation routine 703. The routine 704 and the subsequent routines are the same as those in the operation verification program 700. Thereby, it is possible to verify the execution element while being dedicated to the operand whose highest-order bit is “1” by controlling the operand in the routine 703.

Next, an example will be explained of performing a setting operation such that among two operands such as addition or the like, the first operand is always greater than the second operand. It is possible to cause the first operand to be always greater than the second operand by performing the AND operation on the randomly created first operand and “7fffffffffffffff”; thereafter, the OR operation is performed on the resultant value and “4000000000000000”, and also the AND operation is performed on the second operand and “3fffffffffffffff”. The operand to be verified can be designed by the person who wishes to verify the operand by controlling the data pattern of the operand after randomly creating operands.

Further, another example of an operation verification program for verifying the operation function of the floating-point execution element in the processor shown in FIG. 2 will be explained. This program is fundamentally the same as the operation verification program 700. However, in this program, in the parameter-setting routine 701, the types of instructions are set in addition to the number of instructions and the number of verification patterns. In the present embodiment, an example is explained in which the floating-point addition instruction (fadd) and the floating-point multiplication instruction (fmul) are set. In the case when the cycle time (the reciprocal of the clock frequency) of the processor is 1τ, the respective execution latencies (the number of stages in the execution pipeline) are assumed to be 4τ and 6τ. By this setting of the floating-point addition instruction (fadd) and the floating-point multiplication instruction (fmul), the instructions created in the routine 702 are only the fadd instruction and the fmul instruction having different operation processing timings as shown in FIG. 7C, and not only the floating-point adder and the floating-point multiplier, but also the instruction control unit for verifying the instruction input can be verified for a plurality of instructions having different execution latencies.

Next, a case is explained in which only the floating-point addition instruction (fadd) is set. By this setting operation, only the fadd instruction is created as shown in FIG. 7D, and verification dedicated to the floating-point adder can be performed.

As described above, by managing the instructions to be created by adding methods of controlling the types of instructions when the instructions are created, it is possible to set target execution elements and circuits on the basis of the wishes of the users, and it is also possible to verify the instruction input function in the instruction control unit.

Further, another example is explained of an operation verification program for verifying operation functions of the floating-point execution element in the processor shown in FIG. 2. This program is fundamentally the same as the operation verification program 700. However, in this program, the operand transistor number is given in addition to the number of instructions and the number of verification patterns in the parameter setting routine 701. In the present embodiment, only registers No. 0, No. 2, No. 4, and No. 6 are set to be used. By this setting operation, only the particular operands are used in the instructions created in the routine 702; accordingly, the number (numerical order) of the result register for storing the execution result of the prior instruction and the number (numerical order) of the operand register in the posterior instruction become equal to each other. Thereby, the interference between the succeeding operands is managed and the execution result storing the execution result of the prior instruction is used as the operand of the posterior instruction; accordingly, the bypass can be created for sending the execution result as the operand of the execution element for executing the posterior instruction without waiting until the execution result of the prior instruction is stored in the result register. Thereby, it is possible to verify the instruction control unit on the verification model. By controlling the operand used in the instruction created by adding a method of controlling the register used in the instruction when the instruction is created, it is possible to verify not only the execution unit, but also the instruction control unit for controlling the bypass of data.

In the above explanations, examples of a simulation model have been used. However, it is also possible to verify an actual information processing device by using a program based on the same method.

The operation verification method according to the present invention can verify not only simulations but also operations of actual information processing devices, and is expected to contribute to the shortening of periods for debugging in the design phases and the preproduction phases of information processing devices whose degrees of integration will further increase.

What is claimed is:

1. A method for verifying operations of an operation unit, comprising:
a step of setting a parameter of operation verification of the operation unit;
a step of creating an operation instruction in an operation format executed by the operation unit;
a step of creating operands of the operation instruction at random;
a step of creating an expectation value for the operation instruction and the operand by using another operation unit that executes an operation instruction in an operation format different from a type that is executed by the operation unit;
a step of executing the operation instruction by the operation unit and obtaining an operation result for the operation instruction and the operand; and
a step of comparing the operation result and the expectation value.

2. The method for verifying operations of an operation unit according to claim 1, further comprising a step in which:
in the step of setting a parameter of operation verification of the operation unit, the number of operation patterns is set as a parameter of the operation verification;
in the step of comparing the operation result and the expectation value:
when the operation result and the expectation value correspond to each other, the number of operation patterns that were executed and the number of operation patterns that were set are compared to each other; and
when the comparison result indicates correspondence, operation verification is terminated, and the comparison result indicates non-correspondence, an operation instruction in an operation format executed by the operation unit is created.

3. The method for verifying operations of an operation unit according to claim 1, wherein:
in the step of creating an operation instruction in an operation format executed by the operation unit, operation instructions are created at random.

4. The method for verifying operations of an operation unit according to claim 1, wherein:
in the step of creating an operation instruction in an operation format executed by the operation unit, operation instructions having different operation latencies are created.

5. The method for verifying operations of an operation unit according to claim 1, wherein:
in the step of creating an operation instruction in an operation format executed by the operation unit, an operand register specified by the operation instruction is limited.

6. The method for verifying operations of an operation unit according to claim 1, wherein:
in the step of creating operands of the operation instruction at random, the operand that is a result of logical operation with fixed value data is used for operation verification for the operand created at random.

7. A recording medium used by a computer verifying operations of a processor, recording a program for causing a computer to execute:
a step of creating a plurality of successive verification instructions;
a step of computing all the created successive verification instructions by using an execution element other than a verification target, and obtaining an expectation value of a resultant register and storage region; and
a step of comparing the obtained expectation value and a value of the register and storage region that are results of actual operation by using a verification target execution element.

8. The recording medium according to claim 7, wherein:
when a computer is caused to execute the step of creating an operand related to operation of the verification instruction, creation of the operand is controlled such that operation of the verification instruction is dedicated to a particular data pattern, and the operation is verified.

9. The recording medium according to claim 7, wherein:
when a computer is caused to execute the step of creating the verification instruction, control is performed such that the created verification instruction is an instruction queue dedicated to a particular instruction, and the instruction queue is verified.

10. The recording medium according to claim 7, wherein:
when a computer is caused to execute the step of creating the verification instruction, control is performed such that the created verification instruction specifies a register used in the instruction and is an instruction queue dedicated to a particular register pattern, and the instruction queue is verified.
